(19) United States
(12) Patent Application Publication
(10) Pub. No.: US 2026/0028115 A1
(43) Pub. Date: Jan. 29, 2026

(54) ACOUSTIC ABSORPTION STRUCTURE COMPRISING A PARTITIONING SYSTEM PROVIDED WITH AT LEAST ONE FOOT

(71) Applicant: Airbus Operations SAS, TOULOUSE (FR)

(72) Inventor: José GONCALVES, TOULOUSE (FR)

(21) Appl. No.: 19/277,532

(22) Filed: Jul. 23, 2025

(30) Foreign Application Priority Data
Jul. 25, 2024 (FR) 2408245

(51) Int. Cl. B64C 1/40

(52) U.S. Cl. CPC B64C 1/40

(57) ABSTRACT

An acoustic absorption structure including a cellular structure which comprises tubular cells, closed at each of their ends by an acoustically resistive layer and a reflective layer, and at least one individual partitioning system, placed in a single cell and including a partition configured to separate the cell into first and second compartments, at least one opening passing through the partition, several feet independent of the conduit, having a first end connected to the partition and a second end in contact against the reflective layer, and at least one conduit which has a first end rigidly secured to the partition surrounding the opening and a second end spaced apart from the reflective layer.

### CROSS-REFERENCES TO RELATED APPLICATIONS

This application claims the benefit of the French Patent Application No. FR2408245 filed on Jul. 25, 2024, the entire disclosures of which are incorporated herein by way of reference.

### FIELD OF THE INVENTION

The present application relates to an acoustic absorption structure comprising a partitioning system provided with at least one foot, and to an aircraft including at least one such acoustic absorption structure.

### BACKGROUND OF THE INVENTION

According to one configuration, an aircraft propulsion assembly comprises a primary exhaust nozzle, via which the burnt gases resulting from combustion are discharged, and which includes an acoustic absorption structure in order to attenuate noise in several frequency bands, such as noise relating to combustion (300-1000 Hz) and noise relating to the operation of turbines (greater than or equal to 4000 Hz).

According to a first embodiment of the prior art, an acoustic absorption structure comprises a cellular structure placed between an acoustically resistive layer (porous) in contact with an environment in which acoustic waves propagate, and a reflective layer (impermeable). The cellular structure comprises a multitude of tubular cells each closed at a first end by the acoustically resistive layer and at a second end by the reflective layer. These cells are not compartmentalized and are configured to generally target a single resonance frequency as a function of the height of the cells. This first embodiment makes it possible to obtain a ¼ wave resonator adapted to attenuate high frequency sound waves.

This first embodiment is not entirely satisfactory since it only makes it possible to deal with a small range of frequencies.

According to a second embodiment of the prior art, an acoustic absorption structure comprises first and second superimposed cellular structures, placed between an acoustically resistive layer in contact with an environment in which acoustic waves propagate, and a reflective layer. This acoustic absorption structure comprises an acoustically resistive porous partition inserted between the first and second cellular structures, the first cellular structure being inserted between the acoustically resistive layer and the acoustically resistive porous partition, the second cellular structure being inserted between the reflective layer and the acoustically resistive porous partition.

This second embodiment makes it possible to obtain two types of resonator, a first resonator of ¼ wave type in the cells of the first cellular structure, adapted to attenuate high frequency sound waves, and a second resonator of Helmholtz type in the cells of the second cellular structure, adapted to attenuate low frequency sound waves.

Even though this second embodiment makes it possible to increase the range of frequencies of the acoustic waves treated, it is not entirely satisfactory since, when the acoustic absorption structure is curved, it is difficult to align each of the cells of the first cellular structure with a single cell of the second cellular structure.

### SUMMARY OF THE INVENTION

The present invention aims to overcome all or some of the drawbacks of the prior art.

To this end, the invention relates to an acoustic absorption structure including an acoustically resistive layer, a reflective layer and a cellular structure inserted between the acoustically resistive layer and the reflective layer, the cellular structure including walls which delimit tubular cells, closed at each of their ends by the acoustically resistive layer and the reflective layer, the cellular structure also including at least one partitioning system.

According to the invention, the partitioning system is individual, placed in a single cell and comprises:
a partition configured to separate the cell into first and second compartments, having a peripheral edge in contact sealingly with the wall(s) delimiting the cell in which the partition is placed,
at least one opening passing through the partition and placing the first and second compartments in communication,
at least one conduit which has a first end rigidly secured to the partition surrounding the opening and a second end at a distance from the partition and spaced apart from the reflective layer, and
several feet independent of the conduit, which each have a first end connected directly to the partition and a second end in contact against the reflective layer.

Unlike the prior art which provides for first and second compartments placed in different cellular structures and consequently difficult to align, according to the invention, the first and second compartments are located in the same cellular structure and are therefore automatically aligned even when the acoustic absorption structure is curved. Lastly, the presence of feet makes it possible to ensure that the partition is placed in a position determined as a function of the frequency range of the acoustic waves to be attenuated.

According to another feature, the partition and the conduit are connected by a funnel-shaped junction zone.

According to another feature, the opening and the conduit are centered relative to the peripheral edge of the partition.

According to another feature, the second ends of the feet are flared relative to the first ends.

According to another feature, the partition comprises a rigid central portion and a flexible peripheral portion capable of deforming in order to follow the shapes of the wall(s) delimiting the cell in which the partition is placed.

According to another feature, the central portion of the partition, the foot or feet and the conduit are made in one piece, from the same rigid material.

According to another feature, the acoustic absorption structure comprises a film of adhesive connecting the second end of each foot and the reflective layer.

The invention also relates to an aircraft comprising at least one acoustic absorption structure according to one of the above features.

### BRIEF DESCRIPTION OF THE DRAWINGS

Further features and advantages will emerge from the description of the invention below, which is provided solely by way of example, with reference to the attached drawings in which:

FIG. 1 is a side view of an aircraft,

FIG. 2 is a longitudinal section through part of a propulsion assembly,

FIG. 3 is a longitudinal section through an acoustic absorption structure depicting an embodiment of the invention,

FIG. 4 is a section through a cell of an acoustic absorption structure depicting an embodiment,

FIG. 5 is a perspective view of a partitioning system depicting an embodiment,

FIG. 6 is a perspective view of a partitioning system depicting another embodiment,

FIG. 7 is a perspective view of a partitioning system depicting another embodiment of the invention,

FIG. 8 is a longitudinal section through an acoustic absorption structure including at least one partitioning system as shown in FIG. 6,

FIG. 9 is a longitudinal section through an acoustic absorption structure including at least one partitioning system as shown in FIG. 7.

### DETAILED DESCRIPTION OF THE PREFERRED EMBODIMENTS

According to an embodiment visible FIG. 1, an aircraft 10 includes a fuselage 12, two wings 14, arranged on either side of the fuselage 12, and propulsion assemblies 16 attached under the wings 14. Each propulsion assembly 16 comprises a nacelle 18 and a turbine engine 20 placed inside the nacelle 18.

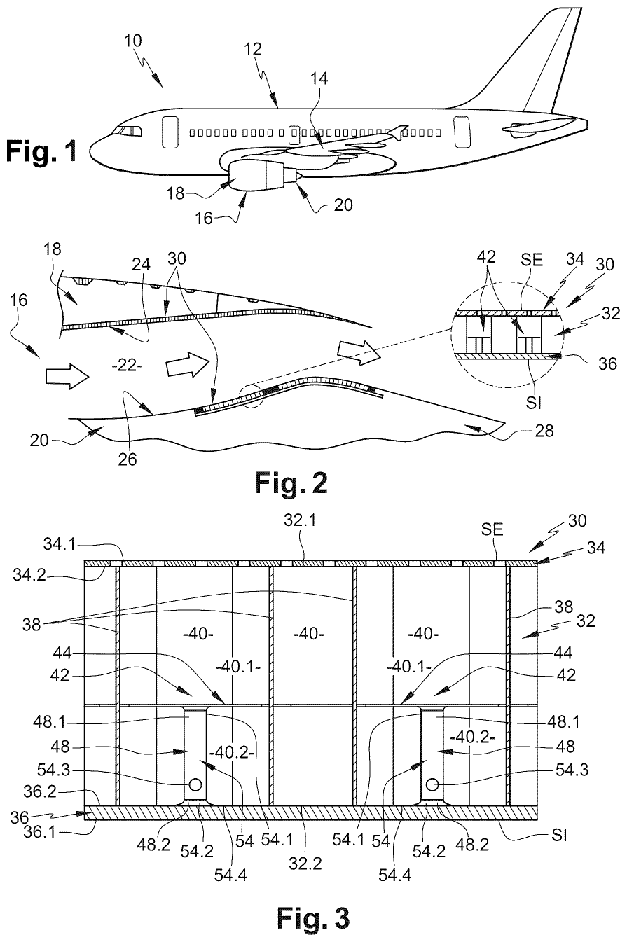

According to an embodiment visible in FIG. 2, the turbine engine 20 comprises, at the rear, a primary exhaust nozzle 22, via which the burnt gases coming from the turbine engine 20 are discharged, which is delimited externally by an outer wall 24 and internally by an inner wall 26 extended by a nozzle cone 28.

According to one configuration, the outer and inner walls 24, 26 each comprise at least one acoustic absorption structure 30.

Each acoustic absorption structure 30 comprises an outer surface SE in contact with an environment in which acoustic waves propagate, and an inner surface SI opposite the outer surface SE.

Although the description applies to a primary exhaust nozzle 22, the invention is not limited to this application. Thus, the acoustic absorption structure 30 may be placed on any wall which has an outer surface SE in contact with an environment in which sound waves propagate.

According to various embodiments shown in FIGS. 2, 3, 8 and 9, an acoustic absorption structure 30 comprises a cellular structure 32 inserted between an acoustically resistive layer 34 that is permeable to sound waves and a reflective layer 36 that is impermeable to sound waves. The acoustically resistive layer 34 has a first face 34.1 corresponding to the outer surface SE and a second face 34.2 oriented toward the cellular structure 32 and connected to the latter. The reflective layer 36 has a first face 36.1 corresponding to the inner surface SI and a second face 36.2 oriented toward the cellular structure 32 and connected to the latter.

The acoustically resistive layer 34, the reflective layer 36, the connection between the acoustically resistive layer 34 and the cellular structure 32 and the connection between the reflective layer 36 and the cellular structure 32 will not be described in more detail since they are identical to those found in the prior art.

The cellular structure 32 extends between a first face 32.1 in contact with the acoustically resistive layer 34 and a second face 32.2 in contact with the reflective layer 36 and comprises a multitude of walls 38 which each have first and second edges positioned respectively at the first and second faces 32.1, 32.2. These walls 38 are configured to delimit tubular cells 40 which each open out on the first and second faces 32.1, 32.2. Each cell 40 is closed at each of its ends by the acoustically resistive layer 34 and the reflective layer 36.

According to an embodiment, the walls 38 are parallel to a longitudinal direction substantially perpendicular to the acoustically resistive layer 34 and/or the reflective layer 36. According to one configuration, the walls 38 are substantially rectangular. Each cell 40 is delimited by six walls 38 and has a hexagonal section. Of course, the invention is not limited to this configuration. As a variant, each wall 38 could be cylindrical and delimit a single cell 40 of circular section.

The cellular structure 32 comprises at least one individual partitioning system 42, placed in a single cell 40 and configured to separate it into first and second compartments 40.1, 40.2. When there are several partitioning systems 42, each is placed in a single cell 40.

According to one configuration, all of the cells 40 of the cellular structure 32 each comprise a partitioning system 42.

According to another configuration, the cells 40 of a zone of the cellular structure 32 each comprise a partitioning system 42.

According to other configurations, only some cells 40 of at least one zone of the cellular structure 32 each comprise a partitioning system 42.

Unlike the prior art in which the partitioning system, in other words the acoustically resistive porous partition, is provided for several cells, inserted between two cellular structures, and separates first and second compartments, positioned respectively in first and second cellular structures, which are difficult to align, the invention provides an individual partitioning system 42, placed in a single cellular structure 32, isolating first and second compartments 40.1, 40.2 provided in the same cell 40. Therefore, the first and second compartments are automatically in the extension of one another, eliminating the difficulty in positioning two cellular structures relative to one another in such a way as to align first and second compartments positioned in different cellular structures placed one against the other.

According to an embodiment, each partitioning system 42 placed in a cell 40 comprises a partition 44 configured to separate the cell 40 into first and second compartments 40.1, 40.2, at least one opening 46 passing through the partition 44 and placing the first and second compartments 40.1, 40.2 in communication, and at least one foot 48 which has a first end 48.1 connected directly or indirectly to the partition 44 and a second end 48.2 in contact against the reflective layer 36.

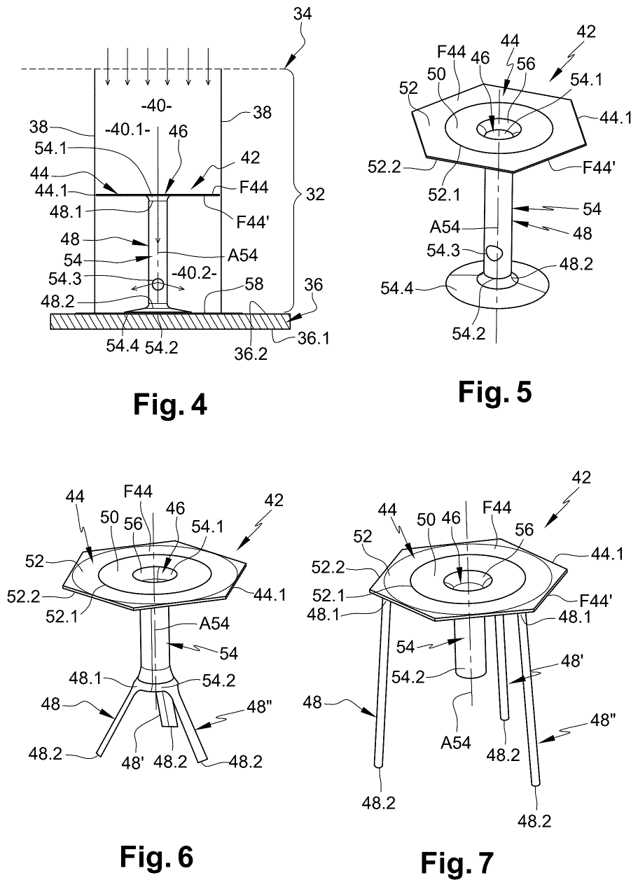

Each partition 44 has a first face F44 oriented toward the acoustically resistive layer 34 and a second face F44′ oriented toward the reflective layer 36. The partition 44 is spaced apart from the acoustically resistive layer 34 and the reflective layer 36, the first compartment 40.1 being positioned between the acoustically resistive layer 34 and the partition 44, the second compartment 40.2 being positioned between the reflective layer 36 and the partition 44. According to one arrangement, the partition 44 is placed in a plane substantially parallel to the acoustically resistive layer 34 and/or to the reflective layer 36. According to one configuration visible in FIG. 4, the partition 44 is located substantially equidistant from the acoustically resistive layer 34 and the reflective layer 36. According to other configurations visible in FIGS. 3, 8 and 9, the partition 44 is closer to the reflective layer 36 than to the acoustically resistive layer 34. The partition 44 is separated from the reflective layer 36 or from the acoustically resistive layer 34 by a distance which is adjusted as a function of the frequencies of the acoustic waves to be attenuated.

Each partition 44 has a peripheral edge 44.1 in contact sealingly with the wall(s) 38 delimiting the cell 40 in which the partition 44 is placed. Thus, the partition has a section delimited by the peripheral edge 44.1 that is greater than or equal to the section of the cell 40 in which the partition 44 is placed.

According to one configuration, the partition 44 comprises a rigid central portion 50 and a flexible peripheral portion 52 capable of deforming in order to follow the shapes of the wall(s) 38 delimiting the cell 40 in which the partition 44 is placed. Thus, the partition 44 may adapt to different sections of cell 40.

The central portion 50 may be made of metal or a rigid composite. The peripheral portion 52 may be made of elastomer.

According to an embodiment, the central portion 50 is a disk and has a circular peripheral edge. The peripheral portion 52 has a circular inner edge 52.1, connected to the central portion 50, and an outer edge 52.2 (corresponding to the peripheral edge 44.1 of the partition 44) which has a shape substantially identical to the section of the cell 40. In the case of a cell 40 of hexagonal section, the outer edge 52.2 is hexagonal.

According to an embodiment, the partition 44 comprises a single opening 46 substantially centered relative to the peripheral edge 44.1 of the partition 44. By way of example, the opening 46 has a passage section smaller than 10% of the section of the cell 40. This percentage is a function of the characteristics sought for the resonator.

According to an embodiment, the partitioning system 42 comprises at least one conduit 54 located in the extension of the opening 46, protruding from the second face F44′ of the partition 44. In the case of a centered single opening 46, the partitioning system 42 comprises a single conduit 54 centered relative to the peripheral edge 44.1 of the partition 44.

According to one configuration, the conduit 54 has a first end 54.1 rigidly secured to the partition 44 surrounding the opening 46 and a second end 54.2 at a distance from the partition 44. According to one arrangement, the partition 44 and the conduit 54 are connected by a junction zone 56 which has a funnel shape and a section which decreases from the first face F44 of the partition 44 to the conduit 54.

According to one arrangement, the conduit 54 is cylindrical and has an axis A54 substantially perpendicular to the partition 44.

According to an embodiment, the partition 44, more specifically its central portion 50, the foot or feet 48 and the conduit 54 are made in one piece, from the same rigid material (metal, plastic or composite, this list not being exhaustive).

According to a first embodiment visible in FIGS. 3 to 5, the second end 54.2 of the conduit 54 is in contact with the reflective layer 36. According to this first embodiment, the conduit 54 and the foot 48 coincide. According to this first embodiment, the conduit 54 has at least one hole 54.3 placing in communication the interior and the exterior of the conduit 54 at a distance from the first and second ends 54.1, 54.2. Thus, the conduit 54 is a hole for discharging the sound waves present in the first compartment 40.1 toward the second compartment 40.2.

To improve the stability of the partitioning system 42, the conduit 54 comprises a collar 54.4 located at the second end 54.2 which extends in a plane substantially perpendicular to the axis A54 of the conduit 54, pressed against the reflective layer 36.

According to other embodiments visible in FIGS. 6 to 9, the second end 54.2 of the conduit 54 is spaced apart from the reflective layer 36. According to these embodiments, the second end 54.2 is open and makes it possible to place the interior and the exterior of the conduit 54 in communication.

According to an embodiment, the partitioning system 42 comprises several feet 48, notably three feet 48, 48′, 48″ spaced apart regularly.

According to an embodiment visible in FIGS. 7 and 9, the feet 48, 48′, 48′ are independent of the conduit 54. In this case, the first ends 48.1 of the feet 48, 48′, 48″ are connected directly to the partition 44.

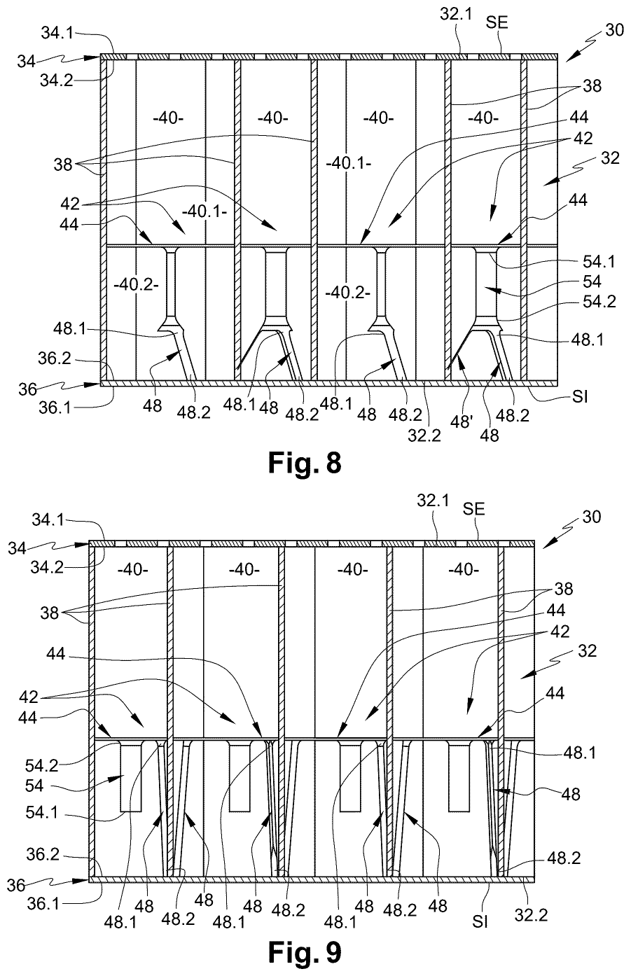

According to another embodiment visible in FIGS. 6 and 8, the conduit 54 is spaced apart from the reflective layer 36. In this case, the first ends 48.1 of the feet 48, 48′, 48″ are connected to the second end 54.2 of the conduit 54. According to one configuration, the second ends 48.2 of the feet 48, 48′, 48″ are flared relative to the first ends 48.1.

According to an embodiment, the second end 48.2 of at least one foot 48, 48′, 48″ is connected by adhesive bonding to the reflective layer 36. According to one configuration, the acoustic absorption structure 30 comprises a film of adhesive 58 rigidly secured to the second face 36.2 of the reflective layer 36, connecting the second end 48.2 of each foot 48, 48′, 48″ and the reflective layer 36.

According to one mode of implementation, a method for manufacturing an acoustic absorption structure comprises a first step of assembling the cellular structure 32 and the reflective layer 36, a step of putting in place each of the partitioning systems 42 in a cell 40 of the cellular structure 32, and a second step of assembling the acoustically resistive layer 34 and the cellular structure 32. The cellular structure 32 may be curved before the first assembly step, after this first assembly step and before the step of putting in place the partitioning systems 42, after this step but before the second assembly step or after the second assembly step.

Whatever the embodiment, the acoustic waves pass through the acoustically resistive layer 34 and enter the first compartment 40.1 which forms a first resonator of ¼ wave type adapted to attenuate high frequency sound waves. Some waves pass through the partition 44 via the opening 46, move through the conduit 54 then leave the conduit via its open second end 54.2 or its hole 54.3, before entering the second compartment 40.2 which forms a second resonator of Helmholtz type adapted to attenuate low frequency sound waves.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An acoustic absorption structure including an acoustically resistive layer, a reflective layer and a cellular structure inserted between the acoustically resistive layer and the reflective layer, said cellular structure including walls, one or more of which delimit tubular cells from other tubular cells, the walls being closed at each of their ends by the acoustically resistive layer and the reflective layer, said cellular structure also including at least one partitioning system;
wherein the partitioning system is individual, placed in a single cell and comprises:
a partition configured to separate the cell into first and second compartment, having a peripheral edge in contact sealingly with the wall or walls delimiting the cell in which the partition is placed,
at least one opening passing through the partition and placing the first and second compartments in communication,
at least one conduit which has a first end rigidly secured to the partition surrounding the opening and a second end at a distance from the partition and spaced apart from the reflective layer, and
several feet independent of the conduit, which each have a first end connected directly to the partition and a second end in contact against the reflective layer.

2. The acoustic absorption structure as claimed in claim 1, wherein the partition and the conduit are connected by a funnel-shaped junction zone.

3. The acoustic absorption structure as claimed in claim 1, wherein the opening and the conduit are centered relative to the peripheral edge of the partition.

4. The acoustic absorption structure as claimed in claim 1, wherein the second ends of the feet are flared relative to the first ends.

5. The acoustic absorption structure as claimed in claim 1, wherein the partition comprises a rigid central portion and a flexible peripheral portion capable of deforming in order to follow shapes of the wall or walls delimiting the cell in which the partition is placed.

6. The acoustic absorption structure as claimed in claim 5, wherein the central portion of the partition, at least one of the feet, and the conduit, are made in one piece, from the same rigid material.

7. The acoustic absorption structure as claimed in claim 1, wherein the acoustic absorption structure comprises a film of adhesive connecting the second end of each of the feet and the reflective layer.

8. An aircraft comprising at least one acoustic absorption structure as claimed in claim 1.
